(19) United States
(12) Patent Application Publication
(10) Pub. No.: US 2008/0013220 A1
(43) Pub. Date: Jan. 17, 2008

(54) Magnetoresistive device, read head and storage having the same

(75) Inventor: Tomohisa Yasukawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/595,692

(22) Filed: Nov. 10, 2006

(30) Foreign Application Priority Data
Jul. 6, 2006 (JP) 2006-187058

(51) Int. Cl. G11B 5/33; G11B 5/127; H04R 31/00

(52) U.S. Cl. 360/319; 29/603.07

(57) ABSTRACT

A method for manufacturing a magnetoresistive device that includes a spin-valve film, and a terminal layer that applies a sense current in a direction of a lamination surface in the spin-valve film, the spin-valve film including a pair of uncoupled ferromagnetic layers, and a non-magnetic metal layer that separates the pair of uncoupled ferromagnetic layers from each other, one of the ferromagnetic layers having a fixed direction of magnetization, and the other of the ferromagnetic layers having a freely variable direction of magnetization includes the steps of forming the terminal layer through sputtering, and preventing a formation of a sharp part on the terminal layer while interrupting the forming step.

This application claims the right of a foreign priority based on Japanese Patent Application No. 2006-187058, filed on Jul. 6, 2006, which is hereby incorporated by reference herein in its entirety as if fully set forth herein.

### BACKGROUND OF THE INVENTION

The present invention relates generally to a magnetoresistive device, and more particularly to a CIP-GMR sensor, which is a magnetic sensor that uses not only a spin-valve film that exhibits a giant magnetoresistive (“GMR”) effect, but also a current-in-plane (“CIP”) configuration that applies the sense current parallel to lamination surfaces in the spin-valve film. The present invention is suitable, for example, for a read head for use with a hard disc drive (“HDD”).

Along with the recent spread of the Internet etc., magnetic disc drives that record a large amount of information including still and motion pictures have increasingly been demanded. As the surface recording density increases to meet the demand for the large capacity, a minimum unit of the magnetic recording information or a 1-bit area reduces on the recording medium, weakening a signal magnetic field obtained from the recording medium. A small, highly sensitive read head is necessary to read this weak signal magnetic field.

A read head that utilizes a CPI-GMR sensor is conventionally known. See, for example, FIG. 1 of Japanese Patent Application, Publication No. 2001-229515. The CIP-GMR head includes a pair of gap layers between a pair of shield layers, and a spin-valve film between the pair of gap layers. A pair of lead terminal parts are provided at both ends of the spin-valve film, and each lead terminal part includes a terminal layer and a hard bias layer. The sense current is applied parallel to the lamination surface of the spin-valve film between both terminal layers.

The highly sensitive read head needs to have an improved shield characteristic or external magnetic field resistance characteristic that shields the external magnetic field. However, the conventional upper shield layer has a set of plural reflex magnetic domains rather than one reflex magnetic domain, as shown in FIG. 9B, causing an insufficient shield effect. According to this inventor's study of the cause, the upper shield layer 60 has undesirable sharp parts 62 and 64 on its side of a gap layer 50 as shown in FIG. 9A. The sharp parts 62 and 64 are likely to form magnetic domain walls, causing longitudinal crack magnetic domains (or a pair of central descending arrows) shown in FIG. 9B. Then, the external magnetic field resistance characteristic (shield characteristic) of the shield layer 60 deteriorates, and an output fluctuates in the MR head device. As the gap layer 50 becomes thinner, influence of a leakage flux LF on a spin-valve film 10 increases, lowering the output.

### BRIEF SUMMARY OF THE INVENTION

Accordingly, it is an exemplified object of the present invention to provide a highly sensitive magnetoresistive device having an excellent shield characteristic, and a read head and storage having the same.

A method according to one aspect of the present invention for manufacturing a magnetoresistive device that includes a spin-valve film, and a terminal layer that applies a sense current in a direction of a lamination surface in the spin-valve film, the spin-valve film including a pair of uncoupled ferromagnetic layers, and a non-magnetic metal layer that separates the pair of uncoupled ferromagnetic layers from each other, one of the ferromagnetic layers having a fixed direction of magnetization, and the other of the ferromagnetic layers having a freely variable direction of magnetization includes the steps of forming the terminal layer through sputtering, and preventing a formation of a sharp part on the terminal layer while interrupting the forming step. This manufacturing method executes the preventing step by interrupting the forming step, and prevents a formation of a sharp part from being formed on the terminal layer. Since it becomes difficult to remove a sharp part of the terminal layer after the forming step is completed, the preventing step is conducted in the middle of the forming step. A sharp part is removed from the shield layer that is laminated on the terminal layer when a sharp part is removed from the terminal layer, and the shield characteristic of the shield layer improves.

The preventing step may include the step of removing, through ion milling, part of the terminal layer that is being formed, while interrupting the forming step, and the method may resume the forming step after the removing step. The part of the terminal layer may be an electrode layer, because the electrode layer is thickest in the terminal layer that includes a lamination of a primary coat, the electrode layer, and a cap layer, and thus can secure a sufficient margin. For example, the removing step may set an angle between an ion beam direction of the ion milling and the direction parallel to the lamination surface to be between a sputtering angle −5° inclusive and the sputtering angle +10° inclusive, the sputtering angle being an angle between a sputtering particle flying direction of the forming step and the direction parallel to the lamination surface. A removal of the sharp part becomes insufficient near the resist outside this range. The removing step may start when a layer of the part of the terminal layer has a thickness between a prospective thickness formed by the forming step −100 Å and the prospective thickness. The removing step may execute the ion milling until a layer of the part of the terminal layer has a thickness between half a prospective thickness formed by the forming step ±100 Å. In this range, the preventing step can secure a sufficient margin, and prevent a formation of the sharp part. The removing step may start the ion milling when the electrode layer of the terminal layer has a thickness between a prospective thickness formed by the forming step −100 Å and the prospective thickness. In this range, the preventing step can secure a sufficient margin, and prevent a formation of the sharp part.

The preventing step may change a sputtering angle between a sputtering particle flying direction of the forming step and the direction parallel to the lamination surface in the middle of the forming step. Thereby, only a sputtering apparatus can prevent a formation of the sharp part on the terminal part without ion milling. The preventing step may set the sputtering angle greater than the sputtering angle of the forming step. For example, the sputtering angle changes between the sputtering angle of the forming step +5° inclusive and the sputtering angle of the forming step +15° inclusive. In this range, a formation of the sharp part can be prevented. Preferably, the preventing step starts when a layer of part of the terminal layer has a thickness between half a prospective thickness formed by the forming step ±100 Å. In this range, the preventing step can secure a sufficient margin, and prevent a formation of the sharp part.

A magnetoresistive device according to another aspect of the present invention includes a spin-valve film that includes a pair of uncoupled ferromagnetic layers, and a non-magnetic metal layer that separates the pair of uncoupled ferromagnetic layers from each other, one of the ferromagnetic layers having a fixed direction of magnetization, and the other of the ferromagnetic layers having a freely changeable direction of magnetization, a lead terminal part that includes a terminal layer that applies a sense current in a direction of lamination surface in the spin-valve film, and a hard bias layer that generates a bias magnetic field, and a shield layer laminated on the spin-valve film and the lead terminal part, wherein the shield layer on a side of the terminal layer has a curved surface shape between a first surface that passes a center of the spin-valve film and is perpendicular to the lamination surface, and a second surface that is parallel to and closest to the first surface, the terminal layer having an approximately constant thickness on the second surface. The shield layer that has a curved surface shape on the terminal layer side and dispenses with the sharp part is likely to secure a reflux magnetic domain, and maintain a predetermined shield characteristic.

The terminal layer may have a curved surface shape on a side of the shield layer. When the shape of the shield layer follows the shape of the terminal shape, a sharp part can be removed from the shield layer. The magnetoresistive device may further include a gap layer between the spin-valve film and a pair of terminal layers and the shield layer, the gap layer having a curved surface shape on a side of the shield layer. In this case, when the shape of the shield layer follows the shape of the terminal shape, a sharp part can be removed from both the gap layer and the shield layer. In addition, only the gap layer is made smooth, and the sharp part may be removed from the shield layer.

A read head according to still another aspect of the present invention includes a magnetoresistive device manufactured by the above manufacturing method or the above magnetoresistive device, a member that supplies a sense current, and a member that reads a signal from an electric resistance of the magnetoresistive device which changes according to a signal magnetic field. This read head has an improved shield characteristic, provides a high sensitivity, and prevents a degradation of an output by reducing the leakage flux. A storage that includes a magnetic head part including the above read head and a write head, and a drive part that drives a magnetic record medium to be recorded and reproduced by the magnetic head part also constitutes another aspect of the present invention.

Other objects and further features of the present invention will become readily apparent from the following description of the preferred embodiments with reference to accompanying drawings.

### BRIEF DESCRIPTION OF THE DRAWINGS

FIG. 1 is a plane view showing an internal structure of a hard disc drive (“HDD”) according to one embodiment of the present invention.

FIG. 2 is an enlarged plane view of a magnetic head part in the HDD shown in FIG. 1.

FIG. 3 is an enlarged sectional view of a lamination structure of a head shown in FIG. 2.

FIG. 4A is a schematic, partially enlarged section of an MR head device shown in FIG. 3. FIG. 4B is a schematic view of a magnetic domain in an upper shield layer shown in FIG. 4A.

FIG. 5 is a flowchart for explaining a sharp part formation preventing method according to a first embodiment of the present invention.

FIGS. 6A to 6C are schematic sectional views of several states corresponding to the flowchart shown in FIG. 5.

FIG. 7 is a flowchart for explaining a sharp part formation preventing method according to a second embodiment of the present invention.

FIGS. 8A to 8C are schematic sectional views of several states corresponding to the flowchart shown in FIG. 7.

FIG. 9A is a partially enlarged section of a conventional CPI-GMR sensor, and FIG. 9B is a schematic view of a magnetic domain of an upper shield layer shown in FIG. 9A.

FIG. 10A is a schematic sectional view of a conventional lead terminal part when the sputtering ends. FIG. 10B is a schematic sectional view showing that part of the lead terminal part shown in FIG. 10A is removed by ion milling.

FIG. 11A is a schematic sectional view of a hard bias layer formed through sputtering. FIG. 11B is a schematic sectional view of a primary coat and an electrode layer laminated on the hard bias layer of the terminal layer through sputtering. FIG. 11C is a schematic sectional view of a cap layer laminated on the electrode layer through sputtering.

### DETAILED DESCRIPTION OF THE PREFERRED EMBODIMENTS

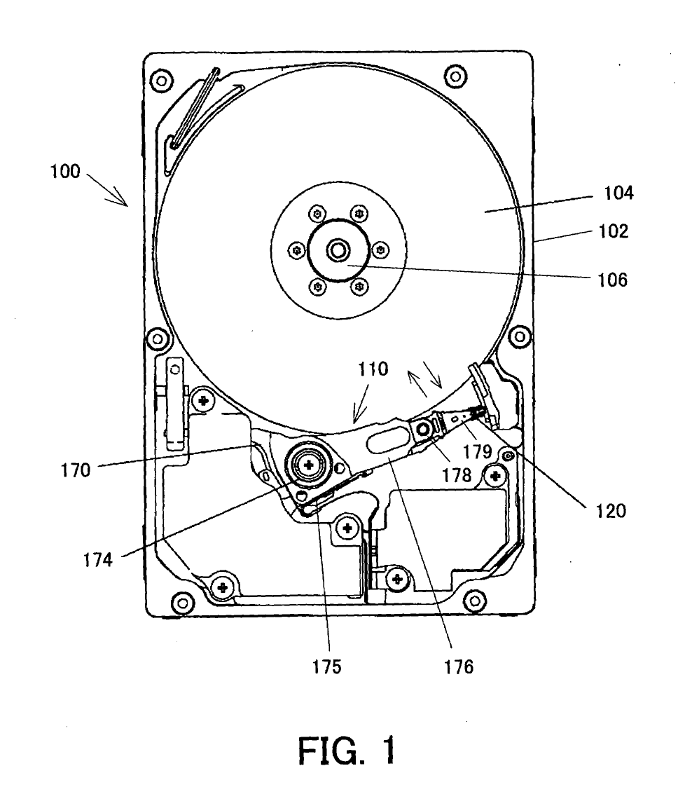

Referring now to the accompanying drawings, a description will be given of an HDD 100 according to one embodiment of the present invention. The HDD 100 includes, as shown in FIG. 1, one or more magnetic discs 104 each serving as a recording medium, a spindle motor 106, and a head stack assembly (“HAS”) 110 in a housing 102. Here, FIG. 1 is a schematic plane view of the internal structure of the HDD 100.

The housing 102 is made, for example, of aluminum die cast base, stainless steel, or the like, and has a rectangular parallelepiped shape to which a cover (not shown) that seals the internal space is joined. The magnetic disc 104 has a high surface recording density, such as 100 Gb/in² or greater. The magnetic disc 104 is mounted on a spindle (hub) of the spindle motor 106 through its center hole of the magnetic disc 104.

The spindle motor 106 has, for example, a brushless DC motor (not shown) and a spindle as its rotor part. For instance, two magnetic discs 104 are used in order of the disc, a spacer, the disc and a clamp stacked on the spindle, and fixed by bolts coupled with the spindle.

The HSA 110 includes a magnetic head part 120, a carriage 170, a base plate 178, and a suspension a carriage 179.

The magnetic head 120 includes a slider 121, a head device built-in film 123 that is jointed with an air outflow end of the slider 121 and has a read/write head 122.

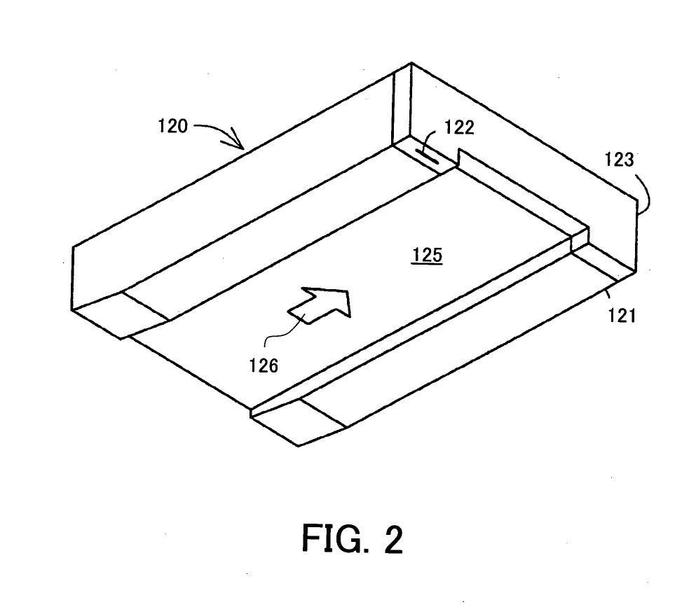

The slider 121 is made of an Al₂O₃—TiC (Altic), approximately rectangular parallelepiped, supports the head 122, and floats over the surface of the rotating disc 104. The head 122 records information into and reproduces the information from the disc 104. A surface of the slider 121 opposing to the magnetic disc 104 serves as a floating surface 125. Here, FIG. 2 is an enlarged view of the magnetic head part 120.

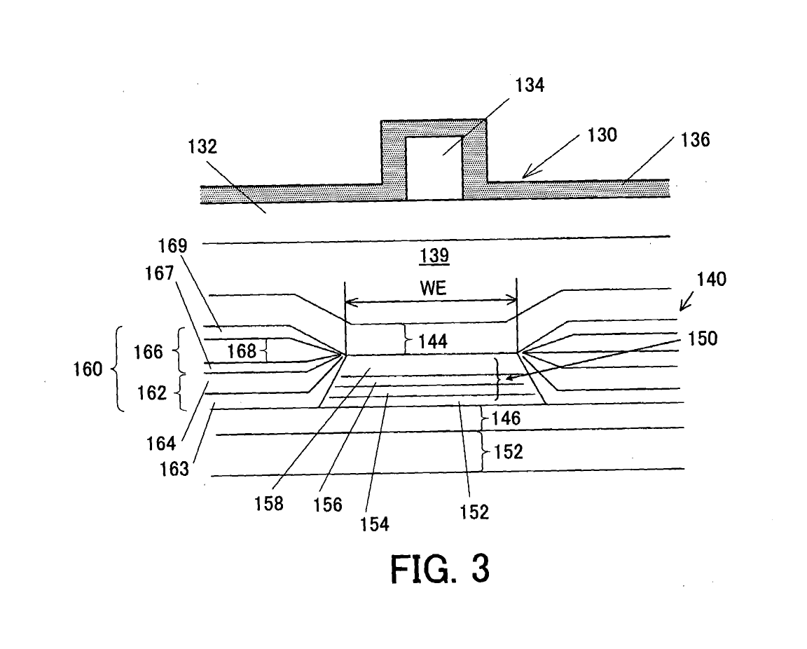

FIG. 3 is an enlarged sectional view of the head 122. The head 122 is, for example, a MR inductive composite head that includes an inductive head device 130 that writes binary information in the magnetic disc 104 utilizing the magnetic field generated by a conductive coil pattern (not shown), and a magnetoresistive (“MR”) head device 140 that reads the binary information based on the resistance that varies in accordance with the magnetic field applied by the magnetic disc 104.

The inductive head device 130 includes a non-magnetic gap layer 132, an upper magnetic pole layer 134, an insulating film 136 made of Al₂O₃, and an upper shield/upper electrode layer 139. As discussed later, the upper shield/upper electrode layer 139 forms part of the MR head device 140.

The non-magnetic gap layer 132 spreads on a surface of the upper shield/upper electrode layer 139, and is made, for example, of Al₂O₃. The upper magnetic pole layer 134 is provided opposite to the upper shield/upper electrode layer 139 with respect to the non-magnetic gap layer 132, and is made, for example, of NiFe. The insulating film 136 covers the upper magnetic pole layer 134 on a surface of the non-magnetic gap layer 132, and forms the head-device built-in film 123. The insulating film 136 is made, for example, of Al₂O₃. The upper magnetic pole layer 134 and upper shield/upper electrode layer 139 cooperatively form a magnetic core in the inductive head device 130. A lower magnetic pole layer in the inductive head device 130 serves as the upper shield-upper electrode layer 139 in the MR head device 140. As the conductive coil pattern induces a magnetic field, a magnetic-flux flow between the upper magnetic pole layer 134 and upper shield/upper electrode layer 139 leaks from the floatation surface 125 due to acts of the non-magnetic gap layer 132. The leaking magnetic-flux flow thus forms a signal magnetic field (or gap magnetic field).

The MR head device 140 includes the upper shield/upper electrode layer 139, a lower shield layer 142, an upper gap layer 144, and a lower gap layer 146, a spin-valve film 150, and a lead terminal part 160.

The shield layers 139 and 142 are made, for example, of NiFe. Thus, the gap layers 144 and 146 are made of an insulating member, such as Al₂O₃.

The spin-valve film 150 includes a free ferromagnetic layer 152, a non-magnetic intermediate layer 154, a pinned magnetic layer 156, and an exchange-coupling layer 158, forming a GMR sensor. Usually, a non-magnetic layer is added, such as Ta, as a protective layer and a primary coat on the exchange-coupling layer 158 and under the free layer 152. A type of the spin-valve film 150 is not limited irrespective of whether it is a top type spin valve, a bottom type spin valve, and a dual valve structure.

The lead terminal part 160 has a hard bias layer 162 that generates a bias magnetic field, and a terminal layer 166 that applies the sense current and defines a device width WE. Thus, the MR head device 140 has a CIP structure that applies the sense current parallel to the lamination surface of the spin-valve film 150 or perpendicular to the lamination direction. The hard bias layer 162 includes, for example, a primary coat 163 that is made of Cr, CrTi alloy, TiW alloy, or the like, and has a thickness of about 50 Å, and a hard layer 164 that is made of such a magnetic material as CoPt alloy, CoCrPT alloy, or the like, and has a thickness of about 200 Å to 250 Å. The terminal layer 166 includes, for example, a primary coat 163 that is made of a non-magnetic layer such as Ta, and has a thickness of about 50 Å, and a cap layer 169 that is made of Ta and has a thickness of about 280 Å.

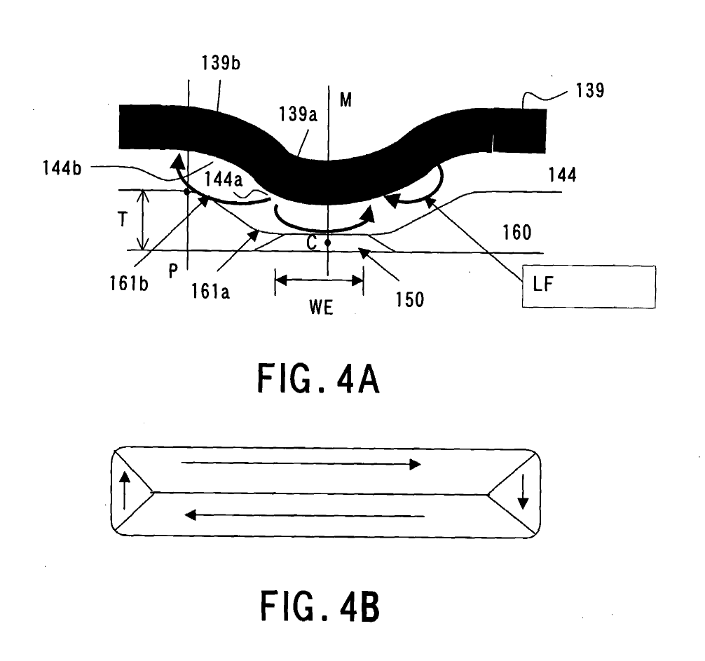

FIG. 4A is a schematic, partially enlarged section of the MR head device 140, and FIG. 4B is a schematic view of a magnetic domain of the upper shield layer 139. As shown in FIG. 4A, portions 161a and 161b of the lead terminal part 160 which correspond conventional sharp parts have a smooth curved surface shape. The corresponding portions 144a and 144b of the upper gap layer 144 on the side of the upper shield layer 139 also have smooth curved surface shapes. The corresponding portions 139a and 139b of the upper shield layer 139 on the side of the lead terminal part 160 also have smooth curved surface shapes, dispensing with the conventional sharp parts. Thus, the upper shield layer 139 has a curved surface shape between a plane M that passes the center C of the spin-valve film 100 and is perpendicular to the horizontal direction (sense current application direction) and a plane P that is parallel to the plane M and closest to the plane M, the lead terminal part 160 having an approximately constant thickness on the plane P.

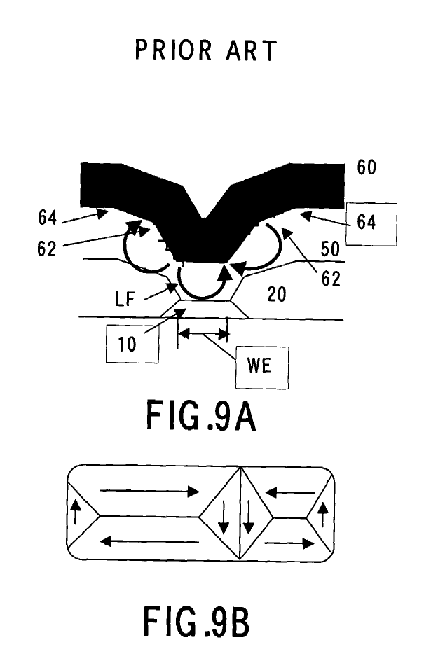

The upper shield layer 139 has a smooth curved surface shape on the side of the lead terminal part 160, and thus an amount of the leakage flux LF having starting points + and end points − in FIG. 4A is less than that shown in FIG. 9A. Since the leakage flux LF shown in FIG. 4A is flatter, smoother, and thus weaker than that shown in FIG. 9A. As a result, the leakage flux LF reduces in quantity and quality in FIG. 4A. While the sharp parts 62 and 64 shown in FIG. 9A are likely to cause longitudinal crack magnetic domains, FIG. 4A removes the sharp parts and thus is likely to be maintain the reflux magnetic domain as shown in FIG. 4B. As a result, the upper shield layer 139 can maintain the intended shield characteristic or external magnetic field resistance characteristic. The MR head device 140 can prevent an output depression through a reduction of the leakage flux LF.

In order for the conventional upper shield layer 60 to realize a structure that makes smoother the upper shield layer 139 on the side of the lead terminal part 160 by removing the sharp part from the upper shield layer 139, this inventor has addressed a shape of the lead terminal part 20. As described later, the shapes of the upper gap layer 144 and the upper shield layer 139 follow the shape of the lead terminal part 160. Thus, if the lead terminal part 20 is smooth and has no sharp part, as shown in FIG. 4A, the upper shield layer 139 can be made smooth on the side of the lead terminal part 160. Nevertheless, it is understood as shown in FIG. 9B that sharp parts 21 and 22 are formed on the conventional lead terminal part 20.

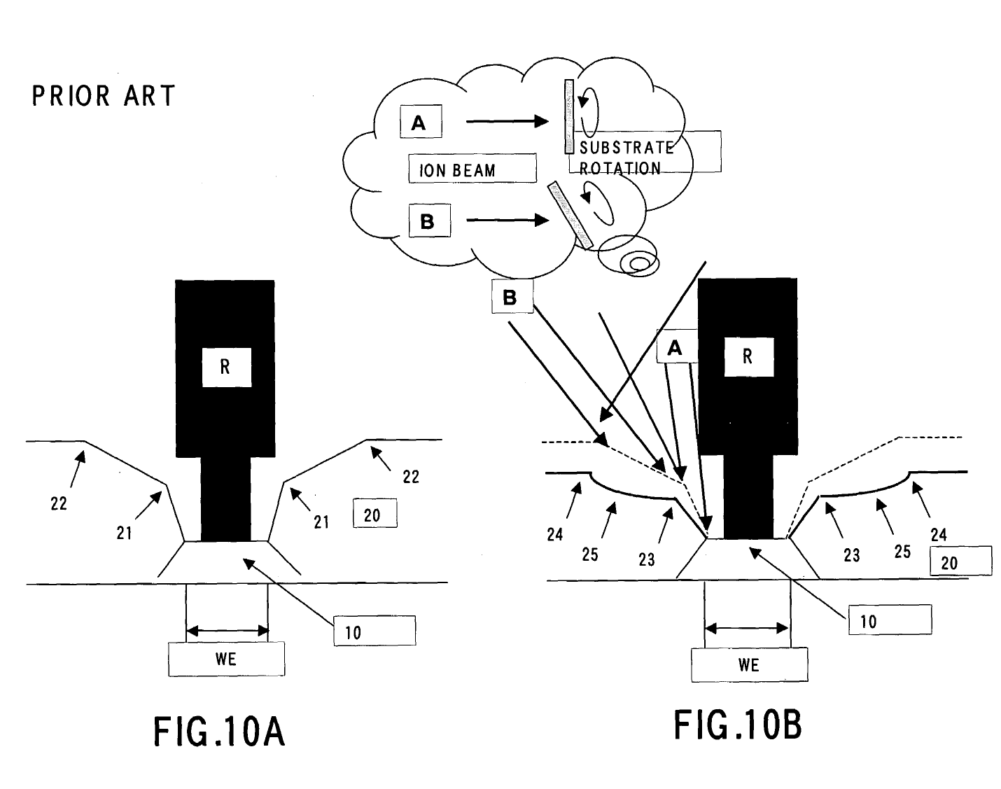

This inventor has first studied a removal of a sharp part formed on the lead terminal part 20 after sputtering of the lead terminal part 20 ends or a lamination formation ends. FIG. 10A is a schematic sectional view after sputtering of the lead terminal part 20 ends. Resist R is formed so as to prevent the lead terminal part 20 from being formed on the spin-valve film 100 when the lead terminal part 20 is sputtered. The resist R is removed after a formation of the lead terminal part 20 ends. The lead terminal part 20 has sharp parts 21 and 22.

In this state, as shown in FIG. 10B, ion milling removes the sharp part 21 near the resist R and the sharp part 22 apart from the resist R. By rotating substrates (or elements 10 and 20), two angles A and B are set between an ion beam irradiating direction and a horizontal plane parallel to the sense current applying direction. The ion beam irradiating angle A is greater than the ion beam irradiating angle B. The A's ion milling can remove the entire surface of the lead terminal part 20, but cause a reattachment of a film and burrs. The B's ion milling cannot remove the lead terminal part 20 near the resist R, and can remove only part apart from the resist R. After all, two sharp parts 23 and 24 and a dent 25 remain on a surface of the lead terminal part 20, and thus the surface of the lead terminal part 20 does not become smooth.

It is thus difficult to remove these sharp parts 21 and 22 from the lead terminal part 20 after sputtering of the lead terminal part 20 ends. One reason is a difficulty of introducing an ion beam into a very small interval between the resist R and the sharp part 21. Accordingly, this inventor has studied a preventive measure of the sharp part formation during sputtering or a lamination formation of the lead terminal part 160, because the interval between the resist R and the sharp part is enough large before the sputtering of the lead terminal part 160 ends.

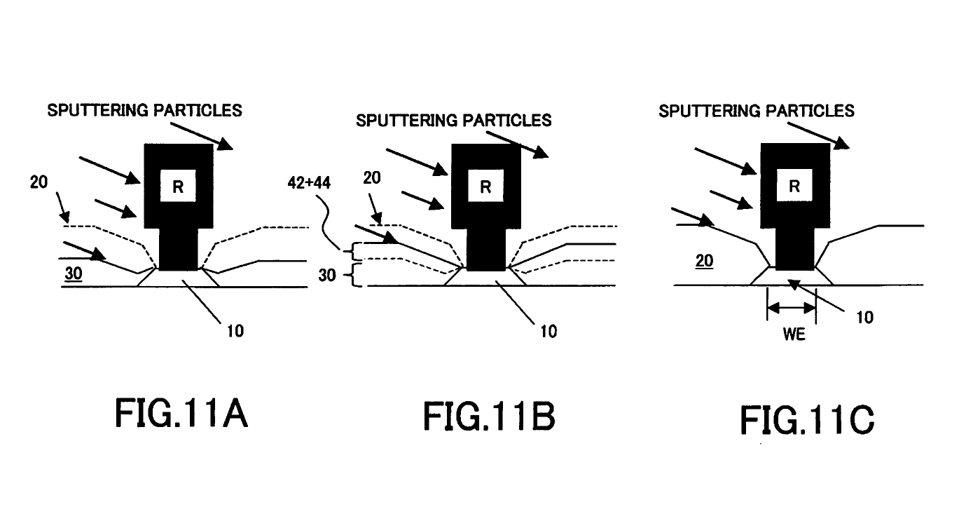

The manufacturing method of the lead terminal part 20 shown in FIG. 10A is initially studied. FIG. 1A is a schematic sectional view of the hard bias layer 30 formed in the lead terminal part 20 through sputtering. In FIG. 11A, a solid line denotes the hard bias layer 30, and a broken line denotes the lead terminal part 20 to be finally formed. FIG. 11B is a schematic sectional view of a primary coat 42 and an electrode layer 44 formed on the hard bias layer 30 in the terminal layer 40 through sputtering. In FIG. 11B, a lower broken line denotes a boundary of the hard bias layer 30, and a solid line denotes a boundary of the electrode layer 44 formed on the hard bias layer 30. An upper broken line denotes the lead terminal part 20 to be finally formed. FIG. 11C shows a schematic sectional view of a cap layer 46 formed on the electrode layer 44 through sputtering. In FIG. 11C, a solid line denotes the finally formed lead terminal part 20.

As a result of an analysis of FIGS. 11A to 11C, this inventor has discovered that the following two methods can prevent a sharp part from being formed on the lead terminal part 20:

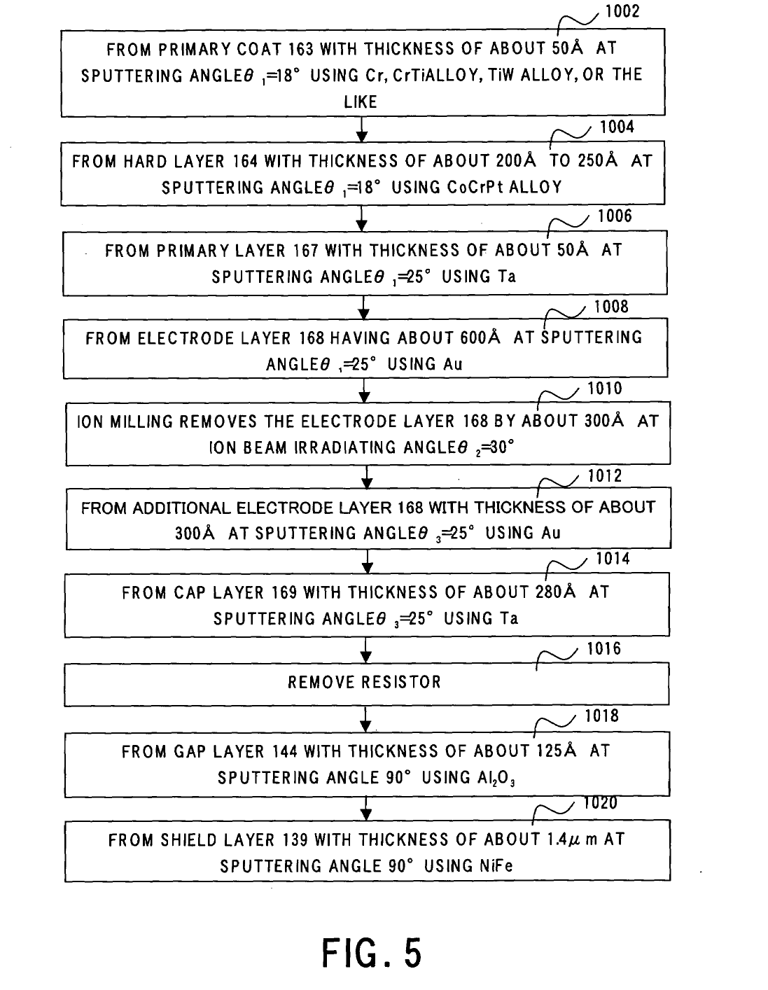

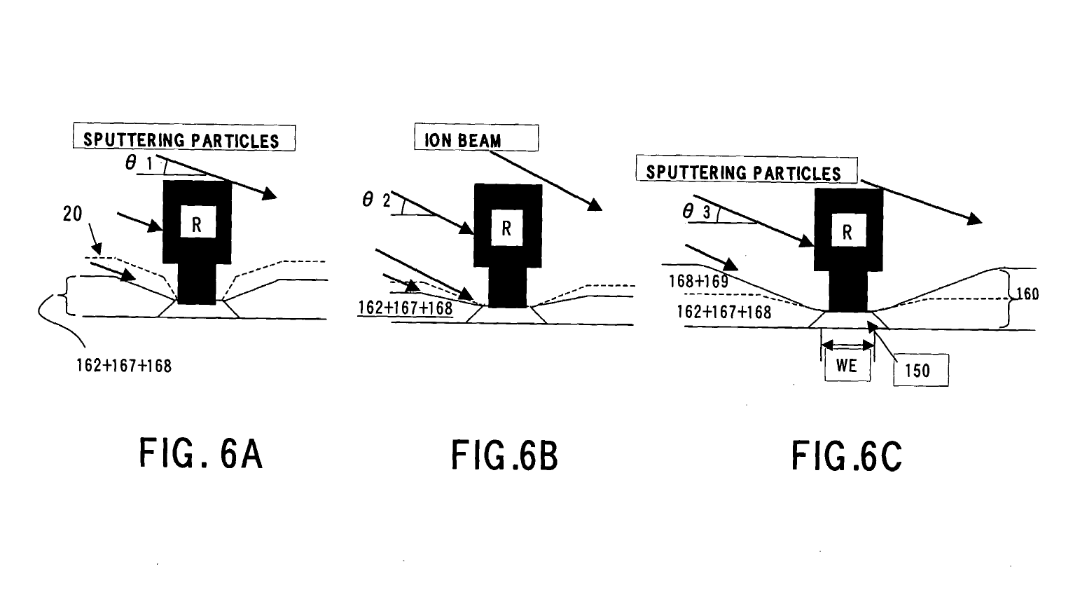

Referring now to FIGS. 5 to 6C, a description will be given of a sharp part formation preventing method according to first embodiment of the present invention. Here, FIG. 5 is a flowchart for explaining the preventive method of the first embodiment, and FIGS. 6A to 6C are schematic sectional views showing several states in this method.

Referring to FIG. 5, the primary coat 163 is formed with a thickness of about 50 Å at a sputtering angle θ₁=18° using Cr, CrTi alloy, TiW alloy or the like (step 1002). Next, the hard layer 164 is formed with a thickness of about 200 Å to 250 Å at a sputtering angle θ₁=18° using CoCrPt alloy (step 1004). Next, the primary coat 167 is formed with a thickness of about 50 Å at a sputtering angle θ₁=18° using Ta (step 1006). Next, the electrode layer 168 is formed with a thickness of about 600 Å at a sputtering angle θ₁=25° using Au (step 1008). FIG. 6A shows this state. In FIG. 6A, a solid line denotes a lamination member (162+167+168), and a broken line denotes the conventional lead terminal part 20 to be finally formed.

Next, ion milling removes the electrode layer 168 by about 300 Å at an ion beam irradiation angle θ₂=30° (step 1010). FIG. 6B shows this state. In FIG. 6B, a solid line denotes a lamination member (162+167+168) (although the electrode layer 168 is scaled or scraped by half a prospective thickness to be formed), and a broken line denotes the lamination member (162+167+168) shown in FIG. 6A. The prospective thickness of the electrode layer 168 is a thickness of the electrode layer 168 shown in FIG. 3, which is 600 Å.

Next, the electrode layer 168 is formed by about 300 Å at a sputtering angle θ₃=25° using Au (step 1012). Next, the cap layer 169 is formed with a thickness of about 280 Å at a sputtering angle θ₃=25° using Ta (step 1014). FIG. 6C shows this state. In FIG. 6C, a broken line denotes the lamination member (162+167+168) (although the electrode layer 168 is scaled or scraped by half a prospective thickness) shown in FIG. 6B, and a solid line denotes the lead terminal part 160. It is understood that a sharp part is removed from the lead terminal part 160 shown in FIG. 6C, like FIG. 4A.

Then, the resist R is removed (step 1016), and the gap layer 144 is formed with a thickness of about 125 Å at a sputtering angle of 90° using Al₂O₃ (step 1018). Next, the shield layer 139 is formed with a thickness of about 1.4 μm at a sputtering angle of 90° using NiFe (step 1020). As shown in FIG. 4A, the upper shield layer 139 is smooth on the side of the lead terminal part 160 after a formation of the lamination ends. Thus, sputtering particles adhere to the entire surface of the substrate at a sputtering angle of 90° in steps 1018 and 1020, and the shapes of the gap layer 144 and the shield layer 139 follow the shape of the lead terminal part 160.

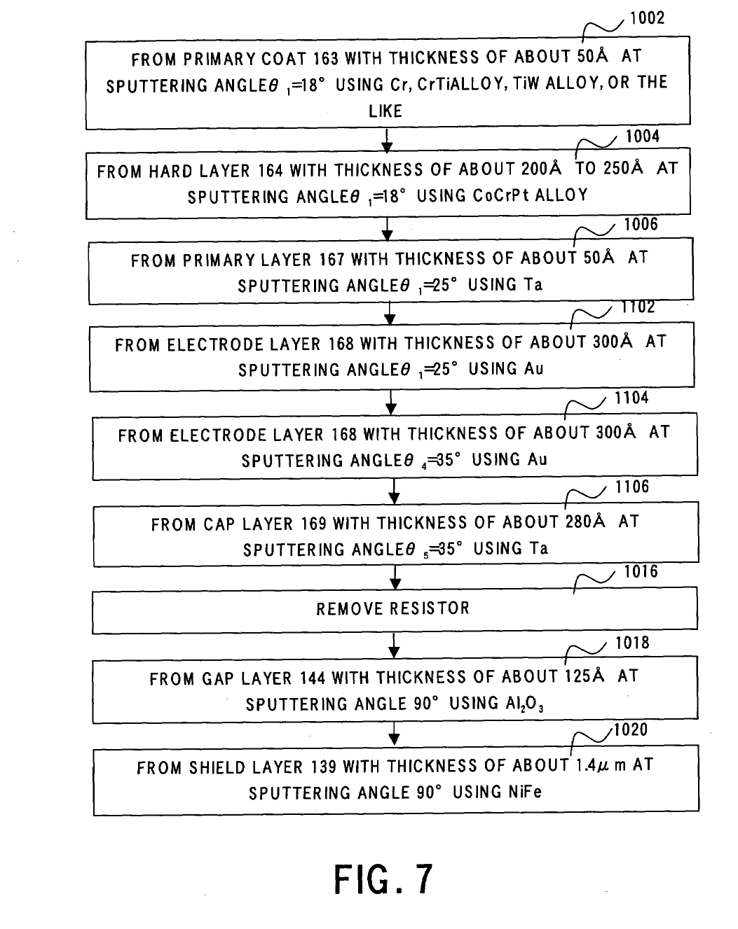

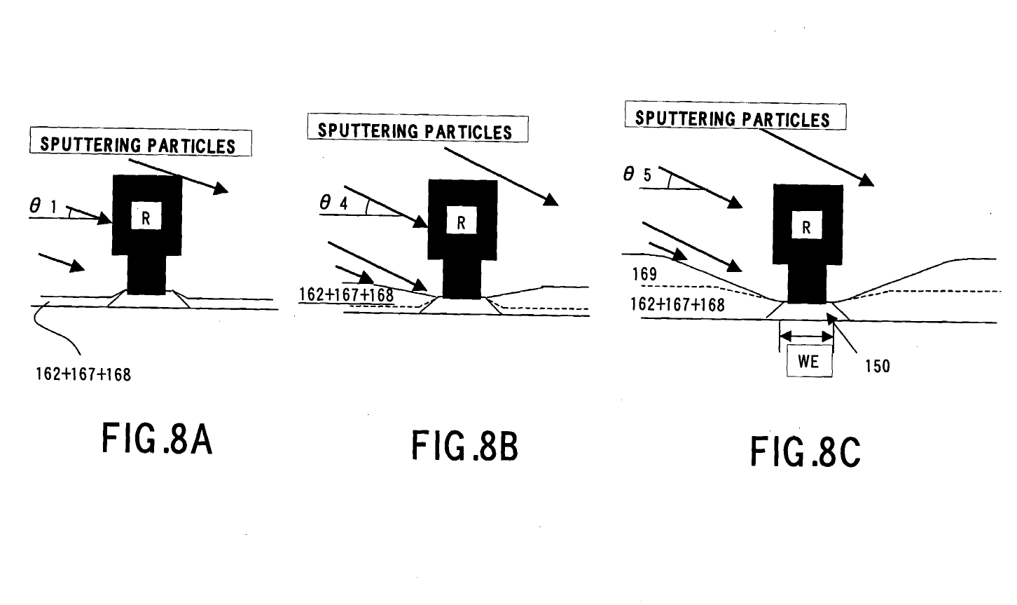

Referring now to FIGS. 7 to 8C, a description will be given of a sharp part formation preventing method according to a second embodiment. FIG. 7 is a flowchart for explaining the sharp part formation preventing method according to a second embodiment, and FIGS. 8A to 8C are schematic sectional views of several states of this method.

Referring to FIG. 7, the primary coat 163 is formed with a thickness of about 50 Å at a sputtering angle θ₁=18° using Cr, CrTi alloy, TiW alloy, or the like (step 1002). Next, the hard layer 164 is formed with a thickness of about 200 Å to 250 Å at a sputtering angle θ₁=18° using CoCrPt alloy (step 1004). Next, the primary coat 167 is formed with a thickness of about 50 Å at a sputtering angle θ₁=18° using Ta (step 1006). Next, the electrode layer 168 is formed with a thickness of about 300 Å at a sputtering angle θ₁=25° using Au (step 1102). FIG. 8A shows this state. In FIG. 8A, a solid line denotes a lamination member (162+167+168) (although the electrode layer 168 has half a prospective thickness).

Next, the electrode layer 168 is formed with a thickness of about 300 Å at a sputtering angle θ₄=35° using Au (step 1104). FIG. 8B shows this state. In FIG. 8B, a solid line denotes a lamination member (162+167+168) (although the electrode layer 168 has the prospective thickness), and a broken line denotes the lamination member (162+167+168) shown in FIG. 8A.

Next, the cap layer 169 is formed with a thickness of about 280 Å at a sputtering angle θ₅=35° using Ta (step 1104). FIG. 8C shows this state. In FIG. 8C, a broken line denotes the lamination member (162+167+168) (although the electrode layer 168 has the prospective thickness) shown in FIG. 8B, and a solid line denotes the lead terminal part 160. It is understood that a sharp part is removed from the lead terminal part 160 shown in FIG. 8C, like FIG. 4A.

Thereafter, the resist R is removed (step 1016), and the gap layer 144 is formed with a thickness of about 125 Å at a sputtering angle of 90° using Al₂O₃ (step 1018). Next, the shield layer 139 is formed with a thickness of about 1.4 μm at a sputtering angle of 90° using NiFe (step 1020). As shown in FIG. 4A, the upper shield layer 139 is smooth on the side of the lead terminal part 160 after a formation of the lamination ends.

Thus, the sharp part formation preventing methods of the first and second embodiments execute the preventive step in the middle of the formation of the lead terminal part 160 or while the lead terminal part 160 is being formed. This is because it is difficult to remove the sharp part once the forming step of the lead terminal part 160 is completed, as described with reference to FIG. 10B. Next, the sharp part formation preventing methods according to the first and second embodiments execute the preventive step in the middle of a formation of the electrode layer 168 or while the electrode layer 168 is being formed. The electrode layer 168 has a thickness of about 600 Å and is thickest in the lamination of the terminal layer 166 that includes the primary coat 167, the electrode layer 168, and the cap layer 169, and thus a sufficient margin can be secured. Of course, the present invention allows the preventive step to be executed in another layer or plural layers in the lead terminal part 160 and the gap layer 144.

While the ion milling in the first embodiment (in the step 1010) sets an angle θ₂ between the ion beam irradiation direction and the horizontal direction to 30°, the present invention allows an angular range between the sputtering angle θ₁=25°−5° inclusive and the sputtering angle θ₁=25°+10° inclusive, with respect to the sputtering angle θ₁ between the horizontal direction and a sputtering particle flying direction of the step 1008 (lamination forming step). A sharp part removal near the resist R becomes insufficient outside this range. While the ion milling in the first embodiment (the step 1010) sets a removal amount by the ion milling to 300 Å, the present invention allows a removal amount range between 300 Å±100 Å by the ion milling, because a sufficient margin can be secured in this range to prevent a formation of the sharp part. While the ion milling in the first embodiment (the step 1010) starts the removal of the ion milling when a formation of the electrode layer 168 ends or when the prospective thickness of 600 Å is obtained, the present invention may start the ion milling when the electrode layer 168 has a thickness from 500 Å to 600 Å, or when the prospective thickness −100 Å is obtained. In this range, the preventive step can secure a sufficient margin and prevent a formation of the sharp part.

The second embodiment changes a sputtering angle in the middle of a formation of the electrode layer 168 or while the electrode layer 168 is being formed, thereby preventing a formation of a sharp part on the lead terminal part 160 only using a sputtering apparatus, i.e., without ion milling. While the second embodiment changes the sputtering angle to 35°, the present invention allows an angular range between the sputtering angle θ₁ of the step 1102 (layer formation step) of 25°+5° inclusive and the sputtering angle θ₁=25°+15° inclusive, i.e., between 30° and 40°. A sharp part removal near the resist R becomes insufficient outside this range. While the second embodiment starts the step 1104 when the electrode layer 168 has a thickness of half a prospective thickness or 300 Å in the step 1102, the present invention allows the step 1104 to start when the thickness of the electrode layer 168 becomes the prospective thickness ±100 Å. In this range, the preventive step can secure a sufficient margin and prevent a formation of the sharp part.

Turning back to FIG. 1, the carriage 170 serves to rotate the magnetic head part 120 in arrow directions shown in FIG. 1 and includes a voice coil motor (not shown), a support shaft 174, a flexible printed circuit board (“FPC”) 175, and an arm 176.

The voice coil motor 174 has a flat coil between a pair of yokes. The flat coil opposes to a magnetic circuit (not shown) provided to the housing 102, and the carriage 170 swings around the support shaft 174 in accordance with values of the current that flows through the flat coil. The magnetic circuit includes, for example, a permanent magnet fixed onto an iron plate fixed in the housing 102, and a movable magnet fixed onto the carriage 170.

The support shaft 174 is inserted into a hollow cylinder in the carriage 170, and extends perpendicular to the paper plane of FIG. 1 in the housing 102. The FPC 175 provides a wiring part with a control signal, a signal to be recorded in the disc 104, and the power, and receives a signal reproduced from the disc 104.

The arm 176 is an aluminum rigid body, and has a perforation hole at its top. The suspension 179 is attached to the arm 176 via the perforation hole and the base plate 178.

The base plate 178 serves to attach the suspension 179 to the arm 176, and includes a welded section and a dent. The welded portion is laser-welded with the suspension 179, and the dent is swaged with the arm 176.

The suspension 179 serves to support the magnetic head part 120 and to apply an elastic force to the magnetic head part 120 against the magnetic disc 104, and is, for example, a stainless steel suspension. This type of suspension has a flexure (also referred to as a gimbal spring or another name) which cantilevers the magnetic head part 120, and a load beam (also referred to as a load arm or another name) which is connected to the base plate. The load beam has a spring part at its center so as to apply a sufficient compression force in a Z direction. The suspension 179 also supports the wiring part that is connected to the magnetic head part 120 via a lead etc.

In operation of the HDD 100, the spindle motor 106 rotates the disc 104. The airflow associated with the rotation of the disc 104 is introduced between the disc 104 and slider 121, forming a minute air film and thus generating the floating power. The suspension 179 applies an elastic compression force to the slider 121 in a direction opposing to the floating power. As a result, the balance occurs between the floating power and the elastic force.

This balance spaces the magnetic head part 120 from the disc 104 by a constant distance. Next, the carriage 170 is rotated around the support shaft 174 for head 122's seek for a target track on the disc 104. In writing, data is received from the host (not shown) such as a PC through the interface, supplied to the inductive head device 130, and written in a target track via the inductive head device 130. In reading, the predetermined sense current is supplied to the MR head device 140, which in turn reads desired information from the desired track on the disc 104. Since the shield characteristic is maintained in the MR head device 140 and the output fluctuation is restrained, a signal can be read at high sensitivity.

Further, the present invention is not limited to these preferred embodiments, and various modifications and variations may be made without departing from the spirit and scope of the present invention. For example, the present invention is applicable to a magnetic sensor (such as a magnetic potentiometer for detecting a displacement and an angle, a readout of a magnetic card, a recognition of paper money printed in magnetic ink, etc.) as well as a magnetic head.

The present invention can provide a highly sensitive magnetoresistive device having an excellent shield characteristic, and a read head and storage having the same.

1-10. (canceled)

11. A magnetoresistive device comprising:
a spin-valve film that includes a pair of uncoupled ferromagnetic layers, and a non-magnetic metal layer that separates the pair of uncoupled ferromagnetic layers from each other, one of the ferromagnetic layers having a fixed direction of magnetization, and the other of the ferromagnetic layers having a freely changeable direction of magnetization;
a lead terminal part that includes a terminal layer that applies a sense current in a direction of lamination surface in the spin-valve film, and a hard bias layer that generates a bias magnetic field; and
a shield layer laminated on the spin-valve film and the lead terminal part, wherein the shield layer on a side of the terminal layer has a curved surface shape between a first surface that passes a center of the spin-valve film and is perpendicular to the lamination surface, and a second surface that is parallel to and closest to the first surface, the terminal layer having an approximately constant thickness on the second surface.

12. A magnetoresistive device according to claim 11, wherein the terminal layer has a curved surface shape on a side of the shield layer.

13. A magnetoresistive device according to claim 11, further comprising a gap layer between the spin-valve film and a pair of terminal layers and the shield layer, the gap layer having a curved surface shape on a side of the shield layer.

14. A read head comprising:
a magnetoresistive device manufactured by a method according to claim 1;
a member that supplies a sense current; and
a member that reads a signal from an electric resistance of said magnetoresistive device which changes according to a signal magnetic field.

15. A read head comprising:
a magnetoresistive device according to claim 11;
a member that supplies a sense current; and
a member that reads a signal from an electric resistance of said magnetoresistive device which changes according to a signal magnetic field.

16. A storage comprising:
a magnetic head part including a read head according to claim 14 and a write head; and
a drive part that drives a magnetic record medium to be recorded and reproduced by said magnetic head part.

17. A storage comprising:
a magnetic head part including a read head according to claim 15 and a write head; and
a drive part that drives a magnetic record medium to be recorded and reproduced by said magnetic head part.
